(19) United States
(12) Patent Application Publication
(10) Pub. No.: US 2010/0303413 A1
(43) Pub. Date: Dec. 2, 2010

(54) ATR PROBE

(75) Inventors: Hakon Mikkelsen, Aldenhoven (DE); Andreas Muller, Ostfildern (DE); Patric Henzi, Karlsruhe (DE)

Correspondence Address: BACON & THOMAS, PLLC, 625 SLATERS LANE, FOURTH FLOOR, ALEXANDRIA, VA, 22314-1176, US

(73) Assignee: Endress + Hauser Conducta Gesellschaft fur Mess- und Regeltechnik mbH + Co. KG, Gerlingen (DE)

(21) Appl. No.: 12/734,845

(22) PCT Filed: Dec. 2, 2008
(86) PCT No.: PCT/EP2008/066656

§ 371 Date: May 27, 2010

(30) Foreign Application Priority Data
Dec. 4, 2007 (DE) 10 2007 058 611.8

(51) Int. Cl. G02B 6/26

(52) U.S. Cl. 385/47

(57) ABSTRACT

An ATR probe includes a monolithic ATR body which has a surface section contactable with a medium; a sending light conductor arrangement for sending non-collimated light into the ATR body; a receiving light conductor arrangement for receiving the sent light after passage through the ATR body, wherein the passage of the light through the ATR body includes at least two total reflections on a media-contacting surface of the ATR body. The area of the receiving light conductor arrangement, for receiving the light emerging from the ATR body is greater than the area of the sending light conductor arrangement for sending the light into the ATR body. The ATR body includes preferably at least one section having a conically, or frustoconically, shaped surface 24, and the frustoconically shaped surface can be supplied, at least sectionally, with the medium.

The present invention relates to an ATR probe for registering an optical property of a medium. The ATR probe includes: A monolithic ATR body, which has at least one surface section contactable with the medium; as well as a sending light conductor arrangement for sending non-collimated light into the ATR body; and a receiving light conductor arrangement for receiving the sent light after passage through the ATR body.

Such an ATR probe is disclosed, for example, in Offenlegungsschrift DE 10 2006 036 409 A1. Such probe uses a single total reflection on the media-contacting surface of an ATR body and has a very simple construction. The sensitivity of this probe is, however, improvable.

US2001/0030288 A1 discloses ATR probes with cylindrical lenses between transmitter and ATR body as well as between the ATR body and a diode line detector.

DE 198 56 591 A1 discloses an ATR probe with two separate light channels.

U.S. Pat No. 5,991,029 A discloses an ATR probe having a plurality of reflections on media-contacting surfaces of an ATR body, wherein the facet with the smallest angle of reflection is reflectively coated, in order to prevent escape of light there.

U.S. Pat. No. 5,773,825 A discloses an ATR probe with a prism for the in-coupling of light and, additionally, a thin optical disk.

U.S. Pat. No. 5,703,366 A discloses, in similar manner, a multipart ATR body with a first crystal body and a crystal disk as well as an optically transmissive interface therebetween.

U.S. Pat. No. 4,826,313 A discloses an ATR probe with optical lenses for collimating divergent ray bundles.

EP 0 206 433 A2 discloses an ATR probe having at least two media-contacting surfaces.

These probes are optically, or constructively, very complex to implement and lead therewith to increased manufacturing costs, especially when the probe is to be integrated into a cylindrical probe shaft of small diameter.

It is, consequently, an object of the present invention to provide an ATR probe, especially one for process-applications, which overcomes the disadvantages of the state of the art, especially has an improved signal to noise ratio, and is suitable for simple batch production. Preferably, the probe is chemically resistant to solvents, bases and acids, as well as to abrasive media.

The object is achieved by the ATR probe defined in independent claim 1.

The ATR probe of the invention for registering an optical property of a medium includes: A monolithic ATR body, which has at least one surface section contactable with the medium; a sending light conductor arrangement for sending non-collimated light into the ATR body; a receiving light conductor arrangement for receiving the sent light after passage through the ATR body, wherein the passage of the light through the ATR body includes at least two total reflections on a media-contacting surface of the ATR body; characterized in that the effective area of the receiving light conductor arrangement, for receiving the light emerging from the ATR body is a factor F greater than the effective area of the sending light conductor arrangement for sending light into the ATR body, wherein F amounts to at least 1,preferably at least 4/3 and further preferably at least 3/2 and especially preferably at least 2, and wherein the sending light conductor arrangement includes at least two sending light conductors and the receiving light conductor arrangement includes at least three receiving light conductors.

In a currently preferred embodiment of the invention, the ATR body includes at least one section having a conically, or frustoconically, shaped surface, and the frustoconically shaped surface is at least sectionally contactable with medium.

The section with the conically, or frustoconically, shaped surface can have, for example, a half-angle of not less than 40 deg and no more than 50 deg, preferably not less than 43 deg and no more than 47 deg, especially 45 deg. The term, half-angle, refers to the angle between the symmetry axis of the cone and the lateral surface of the cone.

In a further development of this embodiment of the invention, the ATR body can include a cylindrical section, which adjoins the base of the conically, or frustoconically, shaped section. The cylindrical section can have, for example, a height amounting to no more than ½, preferably no more than ⅓, further preferably no more than ¼ of the radius of the base of the conically, or frustoconically, shaped section.

In an additional further development of this embodiment of the invention, the ATR body includes a rounded tip, which adjoins the frustoconically shaped section. The rounded tip can have, for example, a radius, which amounts to no more than ⅙, preferably no more than a 1/7, further preferably no more than ⅛ the radius of the base of the frustoconically shaped section.

In a further development, the ATR probe of the invention includes, furthermore, a ferrule, by means of which the sending light conductors and the receiving light conductors are positioned, and a spacing body, which is held between the ferrule and the ATR body, wherein the spacing body can comprise, for example, an over-extending ring.

In a currently preferred embodiment of the invention, the sending light conductor arrangement includes a plurality of sending light conductors, whose end face centers are arranged, according to a further development of the invention, on a circular arc, wherein the circular arc preferably has the cone axis as center.

The end faces of the sending light conductors can, according to an embodiment of the invention, be arranged directly neighboring one another. By this is meant that, between the directly neighboring sending light conductor end faces no receiving light conductor end faces lie. This does, however, not exclude, that the sending, or receiving, light conductors are held in ferrules and, thus, the light conductors including their end faces are separated, or spaced, from one another by ferrule material.

In an embodiment of the invention, the receiving light conductor arrangement includes a plurality of receiving light conductors, whose end faces are arranged in a region, whose shortest closed boundary line surrounds a mapping of the end faces of the sending light conductors, which is obtained by a rotation of the end faces of the sending light conductors around the cone axis by an angle of 180 deg.

The end faces of the receiving light conductors can cover, for example, at least 20%, preferably at least 35% and especially preferably at least 50% of the area of the region, whose shortest closed boundary line surrounds a mapping of the end faces of the sending light conductors, which is obtained by a rotation of the end faces of the sending light conductors around the cone axis by an angle of 180 deg.

In another embodiment of the invention, the receiving light conductor arrangement can comprise a plurality of receiving light conductors, whose end faces are arranged in a region, whose shortest closed boundary line surrounds a simulated mapping of the end faces of the sending light conductors, which arises by the ray path of the light radiated from the sending light conductors into the ATR body under assumption of a numerical aperture in air of not less than 0.1 and no more than 0.3 after two total reflections on the cone shaped, lateral surface of the ATR body and exiting from the ATR body in the plane of the end faces of the receiving light conductors. The simulated representation can occur, for example, under assumption of a numerical aperture in air of no more than 0.15, wherein the end faces of the receiving light conductors, for example, cover at least 20%, preferably at least 35% and especially preferably at least 50% of the area of the region whose shortest closed boundary line surrounds the said simulated mapping of the end faces of the sending light conductors.

In an embodiment, the ATR probe of the invention includes a ferrule, by means of which the sending light conductors and the receiving light conductors are positioned, wherein the optical axes of the sending light conductors, and the receiving light conductors, respectively, extend in the ferrule essentially parallel to the axis of the conically, or frustoconically, shaped section.

In another embodiment, the ATR probe of the invention includes a ferrule, by means of which the sending light conductors and the receiving light conductors are positioned, wherein the optical axes of the sending light conductors, and the receiving light conductors, respectively, in the ferrule are, in each case, as regards the axis of the conically, or frustoconically, shaped section, tilted toward the axis of the cone, so that the k-vector of the light radiated along the optical axis of a sending light conductor in the ATR body has a radially inwardly directed component, and, respectively, the k-vector of the light received along the optical axis of a receiving light conductor in the ATR body has a radially outwardly directed component.

To the extent that the light conductors comprise fibers, the end faces of the fibers extend preferably perpendicularly to the optical axis of the fiber.

In a further development of this embodiment of the invention, the optical axes of the sending light conductors, and, respectively, the receiving light conductors, in the ferrule can define, in each case, parallel to the axis of the conically, or frustoconically, shaped section, a plane, which is rotated as regards a central plane defined by the axis of the conically, or frustoconically, shaped section and the intersection of the optical axis of the respective light conductor with its end face, so that the k-vector of the light radiated along the optical axis of the sending light conductor has in the ATR body a tangential component, and, respectively, the k-vector of the light received along the optical axis of a receiving light conductor has in the ATR body a tangential component.

With said embodiment, the center of area, or the region of maximum intensity of the light doubly reflected by the ATR body, which emerges from a sending light conductors, can, first of all, be shifted radially inwardly in the plane of the end face of the light conductor. Secondly, the center of area, or the region of maximum intensity of the light doubly reflected by the ATR body, which emerges from a sending light conductor, is rotated in the plane of the end face of the light conductor also relative to a point reflection of the receiving fiber at the cone axis. Insofar as it is advantageous to position a receiving light conductor at least in the said center of area, or in the region of maximum intensity, or at least as near as possible thereto, the discussed shifting and rotating of this point enables that the position opposite a sending light conductor can remain free for another sending light conductor. Therewith, for example, even numbered symmetries of sending fiber arrangements are possible, especially quadruple or hexagonal symmetries, wherein hexagonal symmetries enable the greatest packing density of light conductors.

In a further development of the invention, between the end faces of sending light conductors, in each case, end faces of receiving light conductors can be arranged. This means, that the connecting line between points of two neighboring sending light conductor end faces intersects a receiving light conductor end face.

In a further development of the invention, the end faces of the sending light conductors lie on a circle, wherein the centers of the end faces of at least 50% of all receiving light conductors, preferably at least 75% of all receiving light conductors, especially all receiving light conductors, lie within this circle.

According to another point of view of the invention, the sending light conductor arrangement includes at least one sending light conductor, wherein the light emitted by a sending light conductor is captured by two or more receiving light conductors after passage through the ATR body.

In a further development of the invention, the sending light conductors and the receiving light conductor have, in each case, an end face, whose distance from the ATR body amounts to at least λ₀/2 in air, for example, 5 μm preferably at least 100 μm and further preferably at least 200 μm. The value λ₀ refers to the largest wavelength taken into consideration in the evaluation of the ATR-signal. This distance prevents pressure, or temperature, dependent interferences in the air gap between the light conductors (especially light conducting fibers) and the ATR body from modulating intensity of the ATR-signal. A Fabry-Perot-effect is thus largely eliminated. On the other hand, it is advantageous, when the end faces, in each case, have a distance of no more than a diameter of the respective light conductor from the ATR body. In this way, spreading of the light emitted in the air gap is limited.

In a currently preferred embodiment, the ATR probe of the invention includes a ferrule, by means of which the sending light conductors and the receiving light conductors are positioned, and a housing with a media-side opening, as well as a sealing ring arranged around the media-side opening, wherein the ATR body lies against the sealing ring and is axially elastically clamped between the sealing ring and the ferrule. The elasticity can be provided especially by an elastic sealing ring, or by an elastic body, which is arranged at any position in the clamped stretch, thus the sequence of components through which the clamping forces are transmitted, on the rear-side of the ferrule facing away from the ATR body.

The sending light conductor arrangement and the receiving light conductor arrangement are preferably so positioned and oriented, that light which hits surface sections of the ATR body, against which the sealing ring lies, contributes less than 5%, preferably less than 2% and further preferably less than 1% to the signal of the ATR probe.

The ATR body can basically comprise any material, which is transparent in the required spectral range, and has a sufficiently large index of refraction, in order to enable total reflection at interfaces with the media to be examined, especially aqueous media. Furthermore, chemical and abrasive resistance is of advantage. Fundamentally, especially ZnSe, diamond, or sapphire are suitable, or Ge with a DLC-coating, wherein DLC stands for ‘diamond-like carbon coating’.

The sending light conductors, or the receiving light conductors, can preferably comprise optical fibers, which comprise preferably silver halide, quartz, a polymer or chalcogenide, which is sufficiently transmissive in the wavelength range of the light being used.

According to a currently preferred embodiment of the invention, no immersion media, such as oils or adhesives, are used between the light conductors and the ATR body. In accordance therewith, there remains an air gap, which, however, via controlling the distances between the light conductors and the ATR body, does not lead to intensity modulations due to interferences. Additionally, preferably immersion media is omitted from the total beam path of the probe, i.e. also, in the case of the coupling of a source, or of a receiver, to the light conductors.

As alternative thereto, the sending light conductors, or the receiving light conductors can comprise optical hollow conductors, which have an internal coating, which contains, for example, silver halide or Au.

The invention will now be explained on the base of an example of an embodiment illustrated in the drawing, the figures of which show as follows:

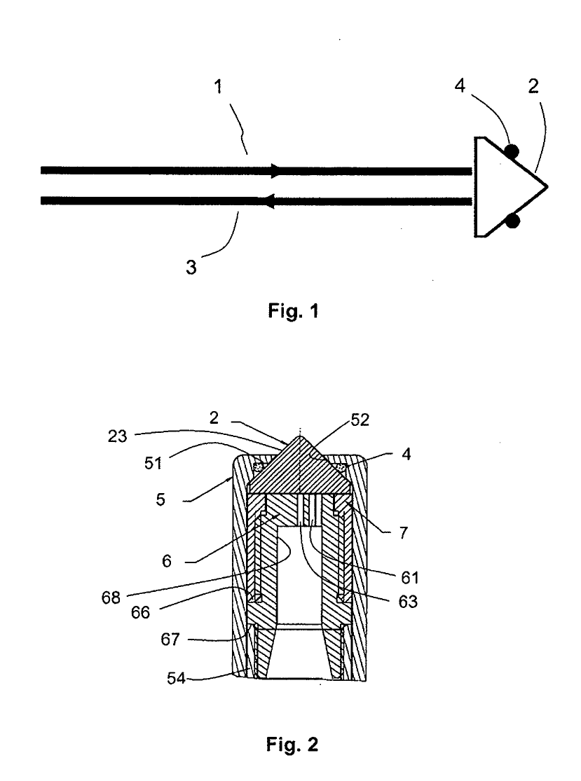

FIG. 1 a sketch of the principles of an ATR probe of the invention having a conical ATR body;

FIG. 2 a sectional drawing of a probe head of an ATR probe of the invention having a conical ATR body;

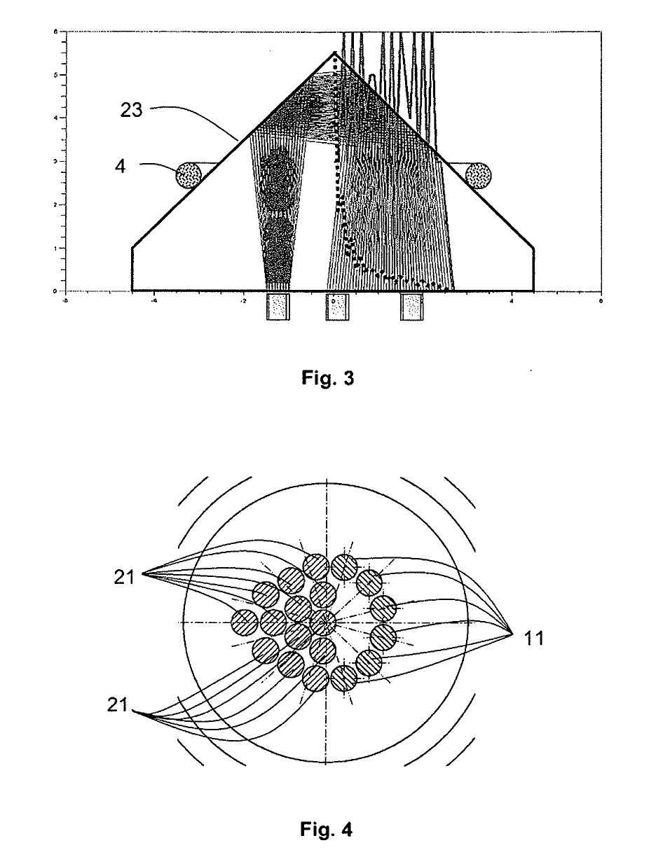

FIG. 3 a sectional drawing through a conical ATR body for the ray calculation of an ATR probe having a conical ATR body;

FIG. 4 a plan view onto an end face of a fiber ferrule for positioning under a conical ATR body according to a form of embodiment of the invention;

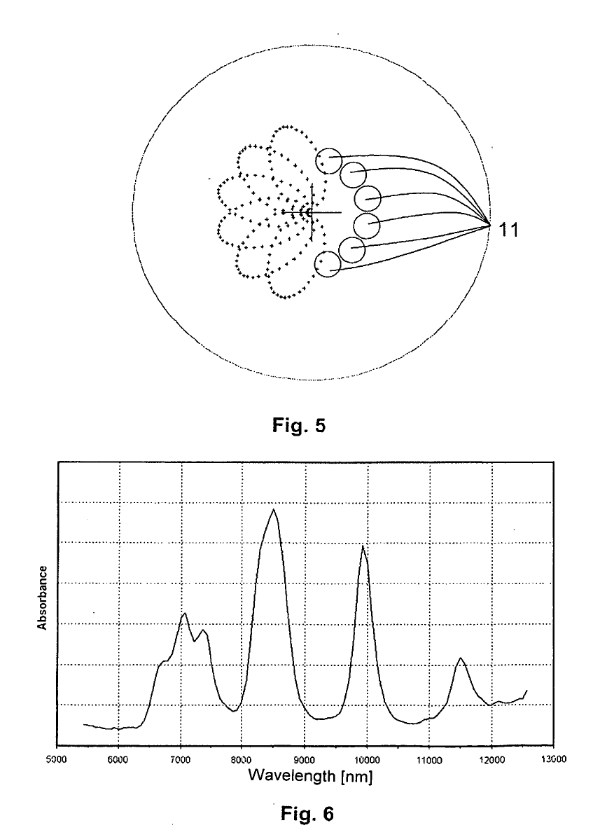

FIG. 5 a projection of the end faces of axially parallel sending light conductors onto the end face of the fiber ferrule with a numerical aperture of the light conductors of 0.25 in air, which corresponds to a half-angle of the light cone emitted by the light conductors of 6 deg in the material of the ATR body.

FIG. 6 a spectrum of isopropanol recorded with an ATR probe of the invention; and

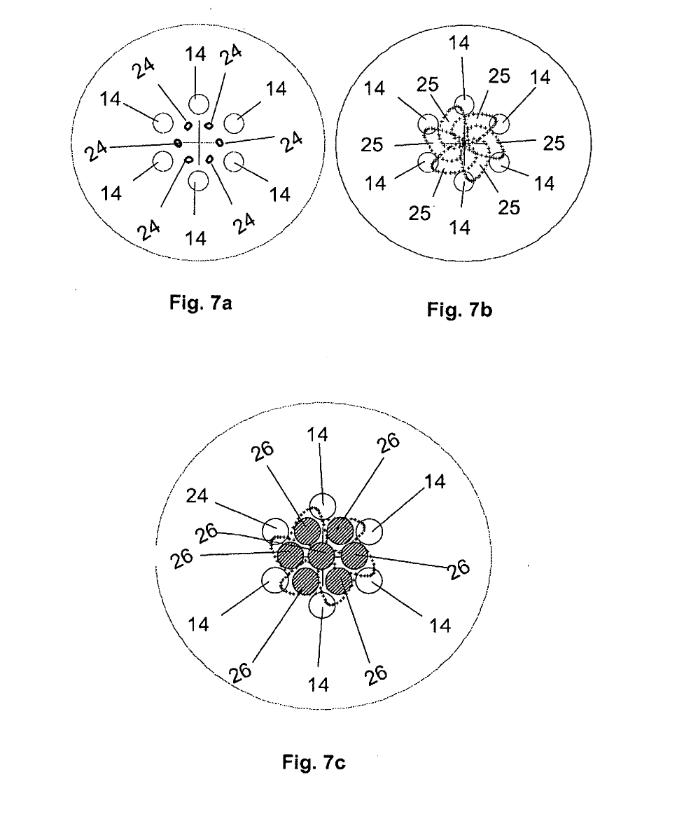

FIG. 7a a projection of the end faces of sending light conductors inclined and rotated with respect to the cone axis, according to another embodiment of the invention, onto the end face of the fiber ferrule with a half-angle of the light cone emitted by the light conductors of 1 deg in the material of the ATR body;

FIG. 7b a projection of the end faces of sending light conductors inclined and rotated with respect to the cone axis, according to another embodiment of the invention, onto the end face of the fiber ferrule with a half-angle of the light cone emitted by the light conductors of 6 deg in the material of the ATR body; and

FIG. 7c a positioning of receiving light conductors resulting from the projections for the arrangement of the sending light conductors in FIGS. 7a and 7b.

FIG. 1 shows the principle of an ATR probe of the invention. Light is radiated via a sending light conductor bundle 1, here a sending fiber bundle, into a cone shaped ATR body 2 at its base and, after two total reflections on the lateral surface of the cone, out-coupled at the base of the ATR body 2 by means of a receiving light conductor bundle, here a receiving fiber bundle 3.

The in-radiating of the light via light conductors, which supply the light from spatially separated sources, and the out-coupling of the light via light conductors to offset receivers enables, on the one hand, the construction of a compact probe head, and, on the other hand, requirements for explosion protection can be well fulfilled.

The construction of a probe head of an ATR probe of the invention is shown in longitudinal section in FIG. 2. The ATR body 2 is an essentially cone-shaped ZnSe crystal with a cylindrical extension on the base 22 of the cone. The ATR body 2 is axially supported in a cylindrical probe housing 5 by means of an elastic O-ring 4 on an encircling sealing surface 51 about a frontal opening 52. At the frontal opening 52, a section of the lateral surface 23 of the ATR body can be supplied with medium to be measured. The O-ring 4 can be, in principle, of any media resistant and temperature resistant material; currently Kalrez material is preferred.

Arranged in the probe housing 5 on the base side of the cone-shaped ATR body is a fiber ferrule 6, with which the light conductors are positioned. For this, the ferrule 6 includes bores 61, 63, in which the fibers are adhered by means of a suitable adhesive, for example, an epoxide resin, which is compatible with the material of the light conducting fibers, wherein the light conducting fibers comprise, especially, silver halide. The fibers are not shown in the drawing, in order to maintain the overviewability of the drawing. Fundamentally, the end face 64 of the ferrule 6 can directly contact the base of the ATR body, wherein, however, it is to be heeded, that the end faces of the fibers should preferably be spaced from the ATR body sufficiently, in order to prevent intensity modulations due to Fabry-Perot interferences. In this regard, either the end faces of the fibers can be set back relative to the end face 64 of the ferrule 6, or, between the ferrule 6 and the ATR body, a spacer is provided, when the end faces 64 of the fibers are essentially flush with the end face of the ferrule. The second alternative is provided here, wherein a screw-on ring 7 is screwed on from the end 64 of the ferrule 6 onto the ferrule until it comes to rest against a first axial stop 66 on the ferrule 6, in order to establish a defined distance between the end face 64 of the ferrule and the base of the ATR body, which lies with a ring-shaped edge surface of its base 22 against the screw-on ring 7.

The ferrule 6 is supported on its rear side by means of a threaded ring 54 in the probe housing 5, wherein the threaded ring 54 engages in a screw thread in the wall of the probe housing 6 and lies against a second axial stop 67, which is embodied as a radial protrusion on the lateral surface of the ferrule 6.

The ferrule includes furthermore a rear side central bore 68, through which the light conductors are led to the respective bores 61, 63 for the positioning of the light conductors.

The ferrule can basically be of any sufficiently form-stable material, which is compatible with the material of the light conductors, or optical fibers, wherein, currently, PEEK is preferred, since it enables a simple and exact manufacture, is cost effective and also has in the case of high temperatures a sufficient mechanical stability.

FIG. 3 is a drawing for ascertaining the positions of the sending light conductors and the receiving light conductors in the optical design.

For optimizing the ATR probe having a conical ATR body, a 2-dimensional ray calculation (ray tracing) is used to determine the light-distribution in the receiving fibers, in each case, with predetermined position of the light source fibers, i.e. the sending light conductors. In such case, it is numerically estimated, how the light passes through the ATR body and how the light source fibers, i.e. the sending light conductors, and the detector fibers, i.e. the receiving light conductors, should be spatially organized in the fiber ferrule, in order that an as high as possible light efficiency and therewith also signal, can be achieved at the detector. In such case, some boundary conditions are to be noted.

First, a large radial distance d_{LS} between the cone axis of the ATR body and the axis of the light source fiber would lead, based on the not negligible numerical aperture NA of the ray bundle, to the fact that the light cone would be distributed upon arrival in the plane of the base of the ATR body, due to the long light path in the ATR body, over too large of an area for the out-coupling into the receiving fibers. In this case, it would be required to work with too many of the expensive receiving fibers. Thus, it is, for reasons of cost, preferable to keep d_{LS} to a minimum.

Second, the conical ATR body receives in manufacture, at its cone tip, a small radius, which, for example, amounts to no more than 0.5 mm. Preferably, no light hits the region of the rounded off cone tip, because this light is lost for the ATR effect. The numerical aperture NA of the installed, light conducting fibers and, thus, the maximal, inwardly pointing ray angle of, for example, 15 deg in air and 6 deg in ZnSe limit the minimum value for d_{LS}.

In optimizing d_{LS} for a cone radius of 4.5 mm, there results the following: At d_{LS}=1.0 mm, light hits the region of the rounded-off cone tip. At d_{LS}=2.0 mm, the light would be distributed over too large of an area, so that too many receiving fibers would be required.

Third, it is to be noted that, preferably, as few light rays as possible fall on the region of the lateral surface where the O-ring is, because such light is lost to absorption in the O-ring material.

As result, there is, in the case of axial parallel orientation of the light conductor axes, a suitable value for d_{LS} lying between, for example, 0.210 and 0.245 base radii, preferably between 0.220 and 0.235 base radii, wherein the base radius is defined by the intersection of the conical surface with the plane of the base of the total ATR body, thus including the cylindrical part. In a currently preferred embodiment, the value for d_{LS} amounts to 0.227 base radii.

In the currently preferred embodiment, the monolithic conical ATR body has a diameter of 9 mm and a 1 mm high cylinder section as base, on which a conical section adjoins with 4.5 mm height and 90 deg cone angle, i.e. a half-angle of 45 deg. The base radius amounts, accordingly, to 5.5 mm. This optical component is produced from ZnSe. FIG. 2 shows a simulation with the entry of the light below left on the base of the ATR body. The light rays are reflected above left on the cone, come to the right upper edge of the cone and are there reflected downwards right in the spatial region, in which the receiving fibers are to be positioned, in order to capture the light.

The light rays of a light conductor are drawn in FIG. 3 as thin lines. For position ascertainment for receiving fibers, first a 2D-histogram is calculated for the light rays arriving on the base of the ATR body (lower right in FIG. 3). The 2D-histogram is shown by the solid thick line. It shows the number of the rays incoming on the base per length unit. The envelope of this distribution corresponds, for instance, to a uniform rectangular distribution. The spike-shaped deviation of the curve from a rectangular distribution is due to the limited number of rays from the light source taken into consideration in the calculating.

The dotted curve represents the distribution of the rays incoming on the base per unit area in a simplified 3D-model. In such case, the number of rays are taken from the 2D-model and divided by the annular area elements, so that this distribution is concentrated toward the center.

The receiving light conductors are to be so positioned, that they capture the light arriving at the base as effectively as possible.

FIG. 4 shows an arrangement of transmitting and receiving light conductors, which takes into consideration the result of the above calculations. For this, there are six sending light conductors 11 with their centers on a radius of 0.227 base radii positioned around the cone axis. Compared to the sending light conductors, the receiving light conductors define a region, in which a sufficiently large part of the light incoming on the base is captured.

Another simulation result of the light distribution is presented in FIG. 5. It shows first the positions of the six sending light conductors of FIG. 4. Additionally, the outer edges of the regions on the base are shown, in which the light of the light cones arrive, resulting from the axially parallel directed sending light conductors, after two total reflections on the conical surface. In such case, a half cone angle of 6 deg was assumed for the light cones. The result confirms, essentially, that the positioning of the receiving light conductors according to FIG. 4 is reasonable and captures a sufficiently large part of the reflected light.

FIG. 6 shows, finally, an absorption spectrum of an aqueous solution of 0.5 WT-% isopropanol, which was recorded by means of the ATR probe. The signal-noise ratio is excellent for a commercial ATR probe.

FIGS. 7a to c show, finally, simulation data for another embodiment of an ATR probe of the invention with a conical ATR body, in the case of which the end faces of six sending light conductors are arranged in hexagonal symmetry on a circle. In such case, the axes of the sending light conductors are inclined radially inwardly. Furthermore, the planes parallel to the cone axis of the ATR body, in which, in each case, the inclined axes of the sending light conductors extend, are indexed by one relative to the respective axial planes, which are defined by the cone axis of the ATR body and the intersection of the axis of a sending light conductor with its end face. As a result, the k-vector of the light radiated along the light conductor axes has a radially inwardly directed component and a tangential component. When the sending light conductor axes, for example, are so oriented in the ferrule, that, for example, the inclination of the axis of the light radiated into the ATR body amounts, for instance, to 6 deg and the rotation relative to the axial plane is, for instance, 40 deg, then the relevant center of the light of a light conductor reflected onto the base surface can be so shifted, that the centers of the light to be out-coupled form with the end faces of the sending light conductors, in first approximation, a hexagonal pattern, wherein the centers fall on gaps between the end faces of the sending light conductors. For identifying the positions of the centers of the light to be out-coupled on the base of the ATR body, a half angle of 1 deg in the ATR body for the radiated light cone was applied. The resulting positions 24 are presented in FIG. 7a together with the end faces 14 of the sending light conductors. FIG. 7b shows the distribution the light 26 to be out-coupled under assumption of a half cone angle of 6 deg in the ATR body for the radiated light cone.

The arrangement of the receiving light conductors 26 resulting therefrom is evident in FIG. 7c. In accordance therewith, at each light point of FIG. 7a, the end face of a receiving light conductor is positioned, while a seventh receiving light conductor occupies the vacancy in the center of the light conductor arrangement. This form of embodiment is, insofar, advantageous, as for each sending light conductor a receiving light conductor is so positioned, that the angular range of maximum intensity around the axis of the in-radiated light is captured by this one receiving light conductor. Additionally, the receiving light conductors are arranged hexagonally, thus in tightest possible packing, this meaning thus also the light falling outside the core region of a reflected light bundle is captured optimally by neighboring receiving light conductors.

1-25. (canceled)

26. An ATR probe for registering an optical property of a medium, comprising:
a monolithic ATR body, which has at least one surface section contactable with the medium;
a sending light conductor arrangement for sending non-collimated light into the ATR body;
a receiving light conductor arrangement for receiving sent light after passage through said ATR body, wherein:
the passage of light through said ATR body includes at least two total reflections on said media-contacting surface of the ATR body;
the effective area of said receiving light conductor arrangement, for receiving light emerging from said ATR body, is a factor F greater than the effective area of said sending light conductor arrangement for sending light into said ATR body, wherein F amounts to at least 1, preferably at least 4/3 and further preferably at least 3/2 and especially preferably at least 2; and
said sending light conductor arrangement includes at least two sending light conductors and said receiving light conductor arrangement at least three receiving light conductors.

27. The ATR probe as claimed in claim 26, wherein:
said ATR body includes at least one section said a conically, or frustoconically, shaped surface, and said frustoconically shaped surface can be supplied at least sectionally with the medium.

28. The ATR probe as claimed in claim 27, wherein:
said ATR body includes a cylindrical section, which adjoins the base of said conically, or frustoconically, shaped section.

29. The ATR probe as claimed in claim 27, wherein:
said ATR body has a rounded tip, which adjoins said frustoconically shaped section.

30. The ATR probe as claimed in claim 26, further comprising:
a ferrule, by means of which said sending light conductors and said receiving light conductors are positioned; and
a spacing body, which is arranged between said ferrule and said ATR body; and
said spacing body comprises, for example, an over-extending ring.

31. The ATR probe as claimed in claim 26, wherein:
said sending light conductor arrangement includes a plurality of sending light conductors.

32. The ATR probe as claimed in claim 31, wherein:
end faces of said light conductors have centers arranged on a circular arc;
said circular arc preferably has the cone axis as its center.

33. The ATR probe as claimed in claim 31, wherein:
the end faces of said sending light conductors are arranged directly neighboring one another.

34. The ATR probe as claimed in claim 31, wherein:
said receiving light conductor arrangement includes a number of receiving light conductors, whose end faces are arranged in a region, whose shortest closed boundary line surrounds a mapping of the end faces of said sending light conductors, which is obtained by a rotation of the end faces of said sending light conductors around the cone axis by an angle of 180 deg.

35. The ATR probe as claimed in claim 34, wherein:
the end faces of said receiving light conductors cover at least 20%, preferably at least 35% and especially preferably at least 50% of the area of the region, whose shortest closed boundary line surrounds a mapping of the end faces of said sending light conductors, which is obtained by a rotation of the end faces of said sending light conductors around the cone axis by an angle of 180 deg.

36. The ATR probe as claimed in claim 31, wherein:
said receiving light conductor arrangement includes a number of receiving light conductors, whose end faces are arranged in a region, whose shortest closed boundary line surrounds a simulated mapping of the end faces of said sending light conductors, which is obtained by the ray paths of light radiated by said sending light conductors into said ATR body under assumption of a numerical aperture of not less than 0.1 and not more than 0.3 after two total reflections on the cone shaped lateral surface of said ATR body and exiting from said ATR body in the plane of the end faces of said receiving light conductors.

37. The ATR probe as claimed in claim 36, wherein:
the simulated mapping is obtained under assumption of a numerical aperture of no more than 0.15 in air; and
the end faces of said receiving light conductors cover at least 20%, preferably at least 35% and especially preferably at least 50% of the area of the region whose shortest closed boundary line surrounds the simulated mapping of the end faces of said sending light conductors.

38. The ATR probe as claimed in claim 27, further comprising:
a ferrule, by means of which said sending light conductors and said receiving light conductors are positioned, wherein:
the optical axes of said sending light conductors, and said receiving light conductors, respectively, extend in the ferrule essentially parallel to the axis of said conically, or frustoconically, shaped section.

39. The ATR probe as claimed in claim 27, further comprising:
a ferrule, by means of which said sending light conductors and said receiving light conductors are positioned, wherein:
the optical axes of said sending light conductors and said receiving light conductors, respectively, in the ferrule are each tilted toward the axis of said conically, or frustoconically, shaped section, so that the k-vector of light radiated along the optical axis of a sending light conductor in said ATR body has a radially inwardly directed component and, respectively, the k-vector of light received along the optical axis of a receiving light conductor in said ATR body has a radially outwardly directed component.

40. The ATR probe as claimed in claim 39, wherein:
the optical axes of said sending light conductors, and, respectively, said receiving light conductors, in the ferrule each define a plane parallel to the axis of said conically, or frustoconically, shaped section which is rotated as regards a central plane defined by the axis of said conically, or frustoconically, shaped section and the intersection of the optical axis of said respective light conductor with its end face, so that the k-vector of the light radiated along the optical axis of said sending light conductor has a tangential component in said ATR body, and, respectively, the k-vector of the light received along the optical axis of a receiving light conductor has a tangential component in said ATR body.

41. The ATR probe as claimed in claim 31, wherein:
between the end faces of said sending light conductors, in each case, an end face of a receiving light conductor is arranged.

42. The ATR probe as claimed in claim 39, wherein:
the centers of the end faces of said sending light conductors define a circle, and the centers of at least half of all receiving light conductors, preferably at least three fourths of all receiving light conductors, especially all receiving light conductors lie within this circle.

43. The ATR probe as claimed in claim 26, wherein:
said sending light conductor arrangement includes at least one sending light conductor; and
light emitted by a sending light conductor is captured after passage through said ATR body by two or more receiving light conductors.

44. The ATR probe as claimed in claim 26, wherein:
said sending light conductors and said receiving light conductors each have an end face and the end faces are each spaced a distance of at least λ₀2 in air, for example, 5 μm, preferably at least 100 μm and further preferably at least 200 μm from a surface section, through which the ray path of light extends from said sending light conductors and to said receiving light conductors, respectively.

45. The ATR probe as claimed in claim 26, wherein:
said sending light conductors and said receiving light conductors each have an end face, and the end faces have each a separation of no more than a diameter of the respective light conductor from said ATR body.

46. The ATR probe as claimed in claim 26, further comprising:
a ferrule, by means of which said sending light conductors and said receiving light conductors are positioned;
a housing with a media-side opening, as well as a sealing ring, which is arranged around the media-side opening; and
said ATR body lies against said sealing ring and is elastically axially clamped between said sealing ring and said ferrule.

47. The ATR probe as claimed in claim 46, wherein:
said sending light conductor arrangement and said receiving light conductor arrangement are so positioned and oriented, that light which hits surface sections of said ATR body, against which said sealing ring lies, contributes less than 5%, preferably less than 2% and further preferably less than 1% to the signal of said ATR probe.

48. The ATR probe as claimed in claim 26, wherein:
said ATR body comprises one of: ZnSe, diamond, sapphire, and Ge with a DLC-coating.

49. The ATR probe as claimed in claim 26, wherein:
said sending light conductors, and said receiving light conductors, respectively, comprise optical fibers, which preferably comprise silver halide, quartz, a polymer, or chalcogenide, which has sufficient transmission in the wavelength range of the used light.

50. The ATR probe as claimed in claim 26, wherein:
said sending light conductors, or said receiving light conductors, comprise optical, hollow conductors, which have an internal coating, which contains, for example, silver halide or Au.
